(19) United States
(12) Patent Application Publication
(10) Pub. No.: US 2025/0303607 A1
(43) Pub. Date: Oct. 2, 2025

(54) SYSTEM AND METHOD FOR HEMP-BASED COMPOSITE PANEL PRODUCTS

(71) Applicants: Miles Gathright, New Smyrna Beach, FL (US); Neil Rohan, New Smyrna Beach, FL (US); Rafael Zamora, Edgewater, FL (US); Cameron Utter, Port Orange, FL (US)

(72) Inventors: Miles Gathright, New Smyrna Beach, FL (US); Neil Rohan, New Smyrna Beach, FL (US); Rafael Zamora, Edgewater, FL (US); Cameron Utter, Port Orange, FL (US)

(21) Appl. No.: 19/090,260

(22) Filed: Mar. 25, 2025

Related U.S. Application Data
(60) Provisional application No. 63/569,920, filed on Mar. 26, 2024.

(51) Int. Cl. B27N 3/02; B27N 3/00; B27N 3/18

(52) U.S. Cl. CPC B27N 3/02; B27N 3/002; B27N 3/183

(57) ABSTRACT

A system and method are provided for producing composite panels using hemp-based materials. The process includes combining hemp hurd, fiber, and dust with an adhesive to form a mixture having a controlled particle size distribution and moisture content. The mixture is subjected to compression at elevated temperature and pressure to form a solid panel with a target density ranging from 20-50 pounds per cubic foot. The process may include the use of additional plant-based materials, such as wheat bran or bagasse, in adjustable proportions. Resulting panels may contain 79% to 91% renewable content and are manufactured without formaldehyde-based binders. The panels are suitable for applications including siding, flooring, cabinetry, and wall systems, and demonstrate reduced environmental impact in terms of energy, water usage, and global warming potential compared to conventional wood-based products. The process allows optional fillers, binders, and reinforcements to customize the panels' properties.

### RELATED APPLICATIONS

Provisional Application No. 63/569,920, filed Mar. 26, 2024, titled “SYSTEM AND METHOD FOR HEMP PANEL PRODUCTS.”

### FIELD OF INVENTION

The present disclosure relates to a system and method for manufacturing panel products using hemp and other agricultural materials.

### BACKGROUND

The following discussion provides background information related to a system and method for hemp panel products, and is not to be deemed admitted prior art.

Hemp is a variety of the Cannabis sativa plant species cultivated for industrial applications. It grows rapidly, reaching maturity in 3-4 months compared to 10-50 years for trees, and offers very low carbon footprint due to its short growth cycle, low resource demands, broad utility, and ability to use nearly all parts of the plant.

Hemp, as used herein and not meant to be limiting, refers to the fibrous stalk portion of the hemp plant, including both the outer bast fibers and the inner hurd or core, which may be processed and incorporated into panel production.

Panels, as used herein and not meant to be limiting, are flat, elongated structures used in construction for covering broad surfaces.

Panels may be applicable in a variety of uses including, not meant to be limiting, siding, roofing, flooring, cabinetry, shelving, paneling, or in any application where plywood, oriented strand board (OSB), fiber cement board, hard panel, or gypsum board might be used.

To provide examples of certain embodiments without limiting their scope, the following description discusses systems and methods for hemp-based composite panel products.

Panels, as referenced herein, are produced in standard 4×8 foot sheets for construction, though other dimensions, configurations, and end uses are contemplated. Other configurations, not meant to be limiting, may include flooring, cabinetry, countertops, tables, desks, furniture.

Conventional panels are made using wood fibers through a multi-step preparation process. Species such as pine, poplar, and aspen are selected, debarked and processed into strands about 3 to 4 inches long, several millimeters thick, and approximately one inch wide. These processes consume significant energy and water resources, with standard MDF production requiring up to 890 MJ of energy and 5,130 liters of water per board.

The strands are combined with adhesives and arranged in layers, with outer layers having strands aligned lengthwise and inner layers oriented crosswise or at various angles. These traditional materials rely on resource-intensive inputs and processes, raising environmental and supply concerns.

Agricultural byproducts and natural fibers, including wheat bran and sugarcane bagasse, can serve as viable materials in high-performance, resource-conscious panel applications. Hemp has drawn attention due to its mechanical properties and favorable cultivation characteristics, including low water and pesticide requirements.

While hemp-based composites offer potential benefits, challenges include material property variability, bonding and process integration, and consistency with industry performance expectations. Manufacturing approaches must be economically viable compared to conventional systems that generate 2.3 kg CO2 eq/kg in carbon emissions.

Traditional panel solutions involve complex production processes, rely on non-renewable materials, and release formaldehyde emissions ranging from 0.05-0.12 ppm. These solutions may not offer the same material profile achievable with hemp-based alternatives containing 75-91% by weight renewable content.

Accordingly, systems and methods incorporating hemp and other renewable materials to form composite panels aim to meet both sustainability goals and commercial performance requirements.

### BRIEF SUMMARY OF THE INVENTION

This summary introduces concepts that are further described in the detailed description. This summary does not identify key features or essential features of the claimed subject matter, nor is it intended to determine the scope of the claimed subject matter.

A system and method for manufacturing pressed hemp panels provides environmental advantages through carbon-negative raw materials and sustainable manufacturing processes. The process combines hemp hurd, fiber, and dust with adhesive binder in specific ratios, with hemp sequestering approximately 1.63 tons of CO2 per ton grown. The system enables production of novel combinations including CannaBran, combining hemp with wheat bran, and CannaCane, combining hemp with bagasse, in ratios between 25%/75% and 75%/25%.

The hemp components undergo decortication to reduce fiber content, with particle sizes from 0.25 mm to 4 mm and moisture content between 5-15%. The mixture incorporates 1-3% 65 binder by volume depending on density, followed by compression under 140-160° C. heat and 15-20 MPa pressure. Panel density ranges from 20-50 pounds per cubic foot based on material composition.

The panels demonstrate 54-72% lower Global Warming Potential compared to traditional wood products, while maintaining functionality as alternatives for siding, roofing, flooring, cabinetry, and wall systems. The manufacturing process reduces environmental impact through 40-54% lower energy consumption and 47% decreased water usage.

The technology enables production of formaldehyde-free panels containing 79-91% renewable content, compared to 0-30% in traditional products. The process accommodates hemp-based inputs and other natural fibers while maintaining compatibility with standard panel manufacturing methods.

### BRIEF DESCRIPTION OF THE DRAWINGS

A system and method for manufacturing pressed hemp panels is illustrated by way of example, and not by way of limitation, in the figures of the accompanying drawings.

While aspects of a system and method for manufacturing pressed hemp panels will be described with reference to the details of the embodiments of the invention shown in the drawings (and some embodiments not shown in the drawings), these details are not intended to limit the scope of the invention.

FIG. 1A shows a flow diagram of the initial material staging and mixing process for manufacturing hemp panels.

FIG. 1B shows a flow diagram of the pressing, cooling and finishing steps of the manufacturing process.

FIG. 2 shows a detailed process flow diagram illustrating moisture content checking, mixing, and panel formation steps.

FIG. 3 shows a flow diagram with testing measurements and panel assembly steps.

FIG. 4 shows hemp input materials in bale form.

FIG. 5 shows the mixing process of hemp materials and binder.

FIG. 6 shows the pressing equipment used in panel manufacturing.

FIG. 7 shows the spreading of the hemp-binder mixture on the molding plate.

FIG. 8 shows the pressing operation of the panel manufacturing process.

FIG. 9 shows the cooling rack assembly used after pressing.

FIG. 10 shows stacked hemp panels awaiting trimming.

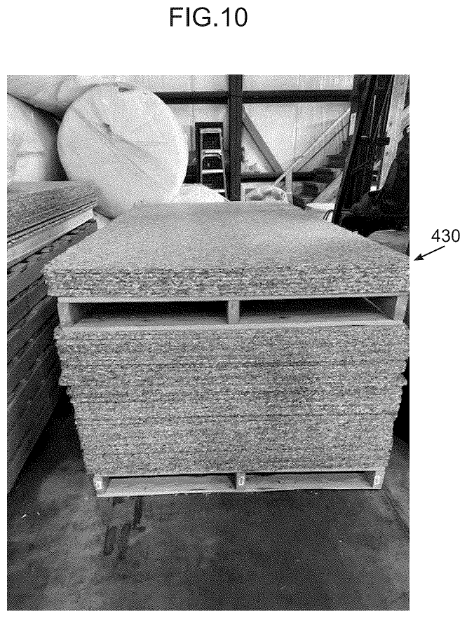

### LIST OF FIGURE ITEMS

110—Hemp input
120—Measure input materials
130—Transfer to mixer
210—Stage binder
220—Measure binder
230—Transfer to mixer
340—Ribbon mixer
350—Transfer to molding plate
360—Screed mix level
365—Proper measure decisions
370—Transfer to press
380—Close press/timer starts
390—Timer ends/open press
400—Remove molding plate
410—Transfer to cooling area
420—Remove board from plate
430—Trim board

### DETAILED DESCRIPTION

The order of the steps in the disclosed processes may be altered within the scope of the invention.

In conjunction with the accompanying drawings, the following detailed description provides a more specific and detailed explanation of various embodiments of the system and method for hemp panel products. These embodiments are provided to illustrate the invention but should not be seen as limiting its scope; the invention can be embodied in many different forms and is intended to be thorough and comprehensive to those skilled in the art.

For the purposes of promoting an understanding of the principles of a system and method for hemp panel products, reference will now be made to the embodiments illustrated in the drawings and specific language will be used to describe the same, only as examples and not intended to be limiting.

Various terms, recognized by those skilled in the art are used herein but not to be limiting. For example, hurd refers to the woody inner parts of the hemp plant stem and is the fibrous core that's left after the bark (the outer layer known as bast fibers) has been removed. Hemp hurd is lightweight and highly absorbent, making it useful for a variety of applications, including animal bedding, construction materials (like hempcrete). Hempcrete, is a sustainable building material made from a mix of hemp hurd, lime, and water.

The hurd particle size may vary in length and width. Furthermore, particles can range from very small pieces to larger chips up to a few centimeters in length.

As used herein, and not meant to be limiting, the term Hempcrete refers to a composite material composed primarily of hemp hurd, water, and lime. Hempcrete, also referred to as Hemplime in certain building code references, such as the International Code Council (ICC), functions as a construction and insulation material. Upon drying, the lime component undergoes a calcification process that contributes to structural integrity while also sequestering carbon from the hemp content and atmospheric sources. The resulting material forms a permeable thermal mass that may aid in regulating both temperature and humidity within a built environment.

As used herein, and not meant to be limiting, the term Hempcrete grade or Animal Bedding grade refers to a classification of hemp hurd characterized by relatively large particle sizes and minimal dust or fines content. In both construction and agricultural contexts, end users generally prefer hurd with longer dimensions and limited presence of smaller particles. This grade of material is primarily composed of clean hurd and is commonly used where coarse, dust-free particulate consistency is required.

As used herein, but not to be limiting, Dirty Hurd is the next lower grade. The hurd is smaller, it has dust as well as short fibers and small fiber bundles. Basically, what is left when the larger hurd for HC/AB grade is screened out. Usually a little cheaper than HC/AB grade.

As used herein, but not to be limiting, Hurd is also called shiv. Hurd is the woody core of the hemp stalk. The hemp fibers or on the exterior of the stalk. Hurd could be a collective term for the hurd fiber and dust because its makeup would still be the majority hurd. Fines will be fines and dust will be dust.

The particle size of the hemp hurd determines the density of the final panel. As particle size decreases, bulk density increases, and the resultant product density will be higher. As particle size increases, bulk density decreases, and the resultant product density will be lower. Particle size distribution peak between 0.5 and 1 mm creates a smoother panel than particle distribution centered at higher levels. Smaller particle sizes create higher density boards and higher density increases material properties of the board

When hemp products are made with a grade of processed hemp referred to as “dirty hurd”, it will contain a majority (50% to 80%) of particles from 0.25 mm (about 0.01 in) to 4 mm (about 0.16 in) in size.

When hemp products are made with a grade of processed hemp referred to as “fines” or “dust”, it will contain a majority (50% to 90%) of particles from 0.25 mm (about 0.01 in) to 2 mm (about 0.08 in) in size.

When hemp products are made with processed hemp referred to as “Hempcrete” or “Animal Bedding” it will be very low in dust content, which would be particle sizes from 0.0612 mm (about 0.002 in) to 0.25 mm (about 0.01 in). This grade will contain a majority (50% to 90%) of particles from 2 mm (about 0.08 in) to 4 mm (about 0.16 in).

Since the bulk density of the hemp goes up as the particle size decreases, the smaller the particle, the heavier the board. All the above “grades” of processed hemp, and their associated blends, and particle distribution schedules, will provide similar material properties in the hempboard panels. The finer the hemp input, the better it mixes with the binder/adhesive. The larger the particle, the lower the board density will be. Dirty Hurd has a combination Advantage of largest supply at scale and lower price than Animal Bedding/Hempcrete grade, which is typically more expensive. The most economical choice is the Hemp Fines. Approximate density values are:

$$\begin{matrix}Animal Bedding / Hempcrete Panel Density 20 - 30 lbs / cuft \\ Dirty Hurd Panel Density 25 - 35 lbs / cuft \\ Fines Panel Density 35 - 45 lbs / cuft \\ Dust Panel Density 45 - 55 lbs / cuft\end{matrix}$$

Disclosed is a system and method for hemp panel products, comprising the following components and steps: (1) a hemp input 110; (2) a binder 210; (3) a ribbon mixer 340; (4) an 185 aluminum bottom plate and aluminum top plate 350; (5) an aluminum frame (6) a wood frame; (7) a press 370; (8) heat and pressure 380 390; (9) a cooling assembly; (9) a cutting table.

These components and steps, generally speaking, are configured as follows: (1) a hemp input 110 of a given size and mixture is selected; (2) a hemp input 110 and a binder 210 are added to a ribbon mixer 340 and mixed for a given time to create a hemp mix; (3) an aluminum bottom with an aluminum frame and a wood frame receives a hemp mix; (4) the hemp mix is leveled 360; (5) a top aluminum plate is placed over the hemp mix; (6) the aluminum bottom plate, hemp mix, and aluminum top plate are loaded into a press as a single assembly 380; (7) heat and pressure are applied to the single assembly 380; (8) once the appropriate amount of time has passed the entire assembly is removed from the press and set on a cooling assembly to cool 410; (9) the aluminum top plate is removed and the resulting hemp panel is then set for trimming to the appropriate size.

A system and method for hemp panel products may also have one or more of the following: (1) fibers of different orientations; (2) a hemp particle distribution that varies from dust to several millimeter; (3) panels of different sizes and thicknesses depending on the frame size used, (4) binders of different viscosities and temperatures during the manufacturing process, (5) additional raw material inputs to create heavier or lighter panels as desired.

The present disclosure relates to hemp-based panel products and methods for manufacturing such products. Hemp-based panel products may provide sustainable alternatives to traditional wood-based panels while offering comparable or superior performance characteristics. These products may utilize industrial hemp fibers and other plant-based materials to create composite panels suitable for various construction and manufacturing applications.

Hemp-based panel products may offer several potential advantages over conventional wood-based panels. In some cases, hemp-based panels may exhibit improved moisture resistance, reduced weight, and enhanced machinability. The use of rapidly renewable hemp as a primary raw material may also provide environmental benefits compared to wood-based alternatives.

The manufacturing methods described herein may allow for the production of hemp-based panels with customizable properties to suit different end-use requirements. Various combinations of hemp materials, binders, and optional additives may be utilized to achieve desired performance characteristics. The disclosed processes may enable efficient and scalable production of hemp-based panel products.

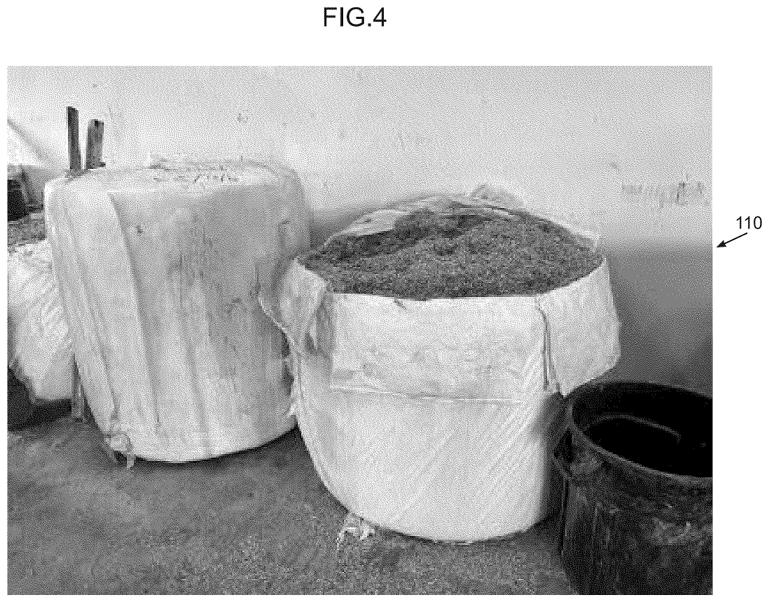

The hemp-based panel products may utilize various hemp input materials, including hemp hurd, fiber, and dust. FIG. 4 shows a section view of a hemp panel product during manufacturing, depicting a hemp input 110 that has been mixed with a binder and formed into a panel shape.

A hemp input 110 may comprise different ratios of hemp hurd, fiber, and dust. The specific composition of the hemp input 110 may affect the properties and performance characteristics of the final panel product. In some cases, the hemp input 110 may contain primarily hemp hurd particles, while in other cases, a higher proportion of hemp fiber or dust may be incorporated.

The moisture content of the hemp input 110 may be an important factor in the manufacturing process. In some cases, the moisture content of the hemp input 110 may range from 5% to 15%. A preferred moisture content range may be 8% to 12%. The moisture content may affect the mixing, forming, and curing processes of the panel product.

The particle size distribution of the hemp input 110 and other natural fibers that may be incorporated can vary. Larger particles of hemp hurd may contribute to a lower density panel, while smaller particles and dust may result in a higher density product. In some cases, the particle size distribution may be adjusted to achieve specific performance characteristics or density targets for the final panel product.

The hemp input 110 may undergo processing steps such as decortication to separate the fibrous outer layer from the woody core of the hemp plant. This process may result in different grades of hemp material, each with distinct particle size distributions and fiber content. The selection and blending of these different grades may allow for customization of the panel properties.

In some cases, the hemp input 110 may be combined with other natural fibers or agricultural byproducts to create hybrid panel products. These additional materials may be selected to complement the properties of hemp and achieve specific performance targets or sustainability goals.

The preparation and conditioning of the hemp input 110 may involve steps to ensure proper moisture content and particle size distribution. These preparatory steps may include drying, screening, or blending operations to achieve the desired input characteristics for the panel manufacturing process.

The hemp-based panel products may incorporate a binder to adhere the hemp materials together and provide structural integrity to the finished panel. A stage binder 210 operation may be performed to prepare the binder for use in the manufacturing process. The binder may then undergo a measure binder 220 step to ensure the proper amount is used in the panel formulation

In some cases, the binder percentage may range from 1-3% by volume of the total panel composition. This percentage may correspond to approximately 4% to 12% by weight, depending on the density of the panel being produced. The specific binder percentage used may be adjusted based on the desired final panel density and performance characteristics.

The temperature of the binder may be an important factor in the manufacturing process. In some cases, the binder temperature may range from 80° F. to 100° F. (approximately 27° C. to 32° C.). Maintaining the binder within this temperature range may help ensure proper viscosity and mixing characteristics with the hemp input 110.

The viscosity of the binder may affect its ability to coat and adhere to the hemp materials. In some cases, the binder viscosity may range from 200 to 700 centipoise, as measured by, but meant to be limiting, a rotary viscometer. This viscosity range may allow for effective distribution of the binder throughout the hemp mixture while maintaining proper flow characteristics during the manufacturing process.

The binder is, not limited to, an adehsive. The binder may be one of, but not limited to, any of the following: agricultural-based adhesives such as soy-based adhesives, hemp-based adhesives, bagasse-based adhesives, wheat-based adhesives, and flower-based adhesives; and fossil fuel-based adhesives that may use urea formaldehyde, phenol formaldehyde, melamine urea formaldehyde, polyvinyl acetate, polyurethane, emulsion polymeric isocyanates, and melamine formaldehyde.

The interaction between the binder and the hemp input 110 may be influenced by factors such as particle size distribution, moisture content, ambient temperature, ambient humidity, and mixing time. The binder may coat the hemp particles and fibers, creating adhesive bonds between individual components as the panel is formed and cured.

In some cases, the binder percentage may be adjusted based on the density of the panel being produced. Higher density panels may require a lower percentage of binder by volume, as the increased compaction of hemp materials may provide additional structural integrity. Conversely, lower density panels may benefit from a higher binder percentage to ensure adequate bonding between more loosely packed hemp particles.

The binder composition may be formulated to provide specific performance characteristics to the finished panel, such as moisture resistance, fire retardancy, or enhanced mechanical properties. In some cases, additives or modifiers may be incorporated into the binder to achieve these desired attributes.

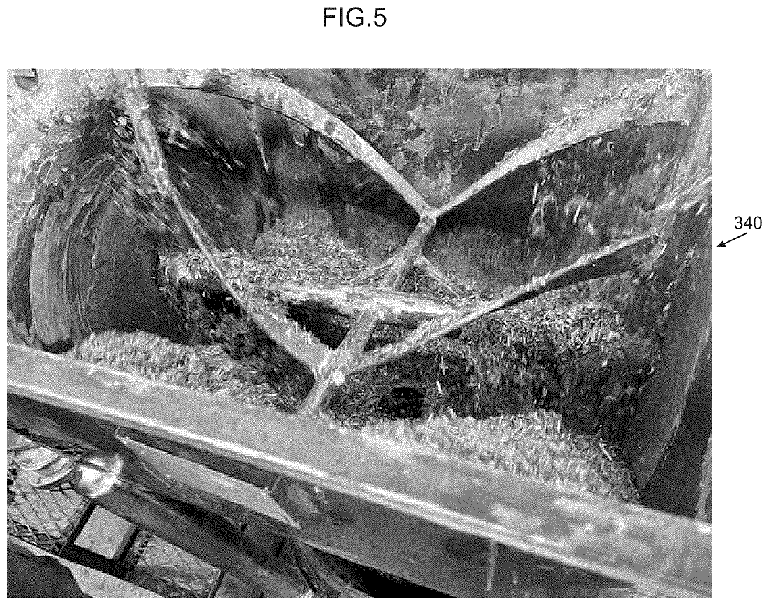

The mixing process may involve combining the hemp input 110 with the binder to create a uniform mixture suitable for panel formation. FIG. 5 shows a section view of a mixing ribbon blender 340, which may be used to blend the hemp and binder materials.

In some cases, a transfer hemp to mixer 130 operation may be performed to move the measured hemp input 110 into the mixing ribbon blender 340. Similarly, a transfer binder to mixer 230 step may be carried out to introduce the measured binder into the mixing ribbon blender 340.

The mixing ribbon blender 340 may utilize a series of helical ribbons or paddles to agitate and combine the hemp and binder materials. This mixing action may help ensure thorough distribution of the binder throughout the hemp particles and fibers.

The duration of the mixing process in the mixing ribbon blender 340 may vary depending on factors such as the specific hemp input 110 composition, binder properties, and desired final panel characteristics. In some cases, the mixing time may range from 5 to 10 minutes. A typical mixing duration may be 7 to 8 minutes, which may allow for adequate blending while avoiding potential issues related to premature binder reaction in high heat and humidity conditions.

The mixing process may be influenced by the temperature and viscosity of the binder, as prepared during the stage binder 210 and measure binder 220 steps. The mixing action in the mixing ribbon blender 340 may help distribute the binder evenly throughout the hemp materials, coating individual particles and fibers to facilitate bonding during subsequent panel formation steps.

In some cases, the mixing process may be adjusted based on visual inspection or automated monitoring of the mixture consistency. The mixing time or speed may be modified to achieve the desired uniformity and binder distribution within the hemp-binder mixture.

The mixing ribbon blender 340 may be designed to accommodate different batch sizes and material compositions, allowing for flexibility in panel production. The blender may incorporate features such as variable speed control or reversible mixing action to optimize the blending process for different hemp-binder formulations.

Following the mixing process in the mixing ribbon blender 340, a transfer to molding plate 350 operation may be performed to move the hemp-binder mixture onto a forming surface. The transfer to molding plate 350 may involve conveying the blended material from the mixing ribbon blender 340 to a flat plate or tray where the panel will be formed.

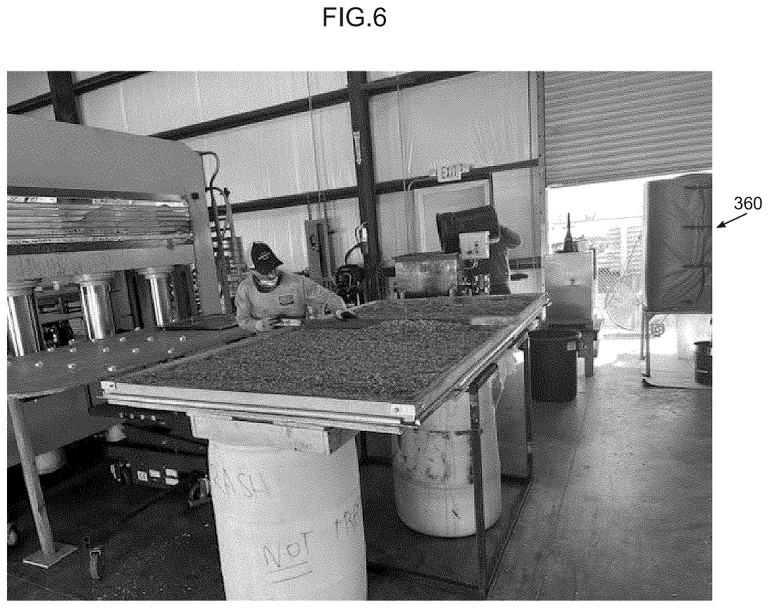

Once the hemp-binder mixture is on the molding plate, a screed mix level 360 process may be carried out to ensure even distribution and thickness of the material. FIG. 6 shows an orthogonal view of a manufacturing setup for leveling composite board material. The screed mix level 360 operation may utilize a straight edge or bar to spread the mixture uniformly across the molding plate surface. Typically, the mix is deposited on the plate and move around by hand to best distribute the mix over the plate. Then a screed is used to level the mix to a consistent height. Any low spots are filled in during the screeding process.

The screed mix level 360 process may be critical for achieving consistent panel thickness and density. In some cases, the screed may be adjusted to accommodate different panel thicknesses. The final board dimensions may be customized, with standard sizes of 4′×8′ sheets in thicknesses ranging from ¼″ to 1½″.

After the screed mix level 360 operation, a proper measure decision 365 may be made to evaluate whether the material distribution and thickness meet the desired specifications. The proper measure decision 365 may involve visual inspection or automated measurement techniques to ensure the panel formation is proceeding as intended.

In some cases, if the proper measure decision 365 determines that adjustments are needed, the screed mix level 360 process may be repeated or fine-tuned to achieve the desired material distribution. This iterative process may help ensure that the hemp-binder mixture is evenly spread and at the correct thickness before proceeding to subsequent manufacturing steps.

The molding and leveling process may be influenced by factors such as the viscosity of the hemp-binder mixture, the particle size distribution of the hemp input 110, and the desired final panel density. The screed mix level 360 operation may be adjusted to accommodate different material compositions and panel specifications.

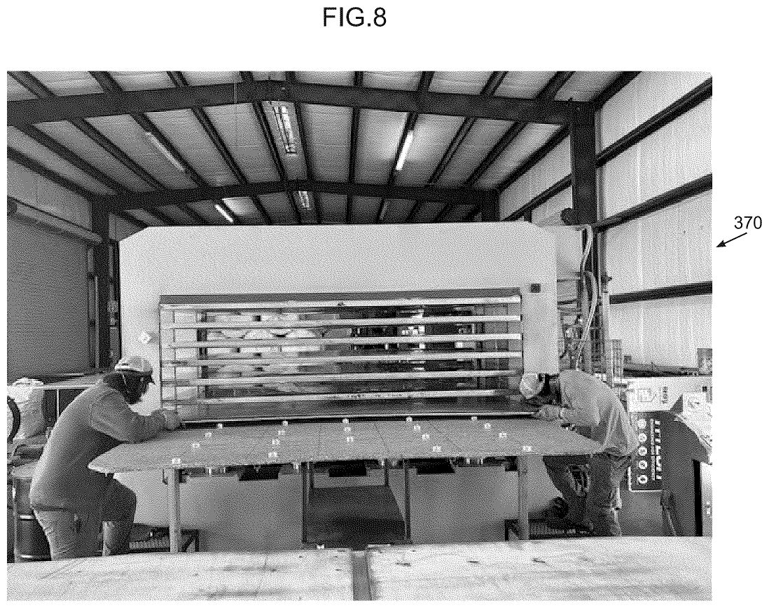

Following the screed mix level 360 operation and proper measure decision 365, a transfer to press 370 operation may be performed to move the formed hemp-binder mixture into a press for curing and consolidation. FIG. 8 shows an orthogonal view of a manufacturing setup for pressing hemp board materials, depicting the transfer to press 370 operation.

Once the material is positioned in the press, a close press/start timer 380 step may be initiated to begin the pressing and heating cycle. The pressing and heating process may cure the binder and contribute to desired panel properties.

In some cases, the press heat may range from 140° C. to 160° C. This temperature range may allow for proper activation and curing of the binder while avoiding potential degradation of the hemp materials. The specific temperature used may be adjusted based on factors such as panel thickness, binder composition, and desired curing time.

The press pressure applied during the curing process may range from 15-20 MPa. This pressure range may help ensure proper compaction of the hemp-binder mixture and facilitate the formation of a uniform, dense panel structure. The applied pressure may influence factors such as panel density, surface smoothness, and overall dimensional stability.

The duration of the pressing and heating cycle may vary depending on factors such as panel thickness, press temperature, and binder characteristics. In some cases, the cycle time may be controlled by a timer, with a timer ends/open press 390 step signaling the completion of the curing process.

The combination of heat and pressure during the pressing operation may activate the binder, causing it to flow and create adhesive bonds between the hemp particles and fibers. This curing process may result in the transformation of the loose hemp-binder mixture into a solid, cohesive panel structure.

The pressing and heating process may influence various properties of the final hemp-based panel product. Factors such as panel density, dimensional stability, and surface characteristics may be affected by the specific temperature, pressure, and duration parameters used during this stage of manufacturing.

In some cases, the pressing and heating process may be optimized to achieve specific performance targets for the hemp-based panels. This optimization may involve adjusting parameters such as press temperature, pressure, and cycle time based on the particular hemp input 110 composition and binder formulation used in the panel production.

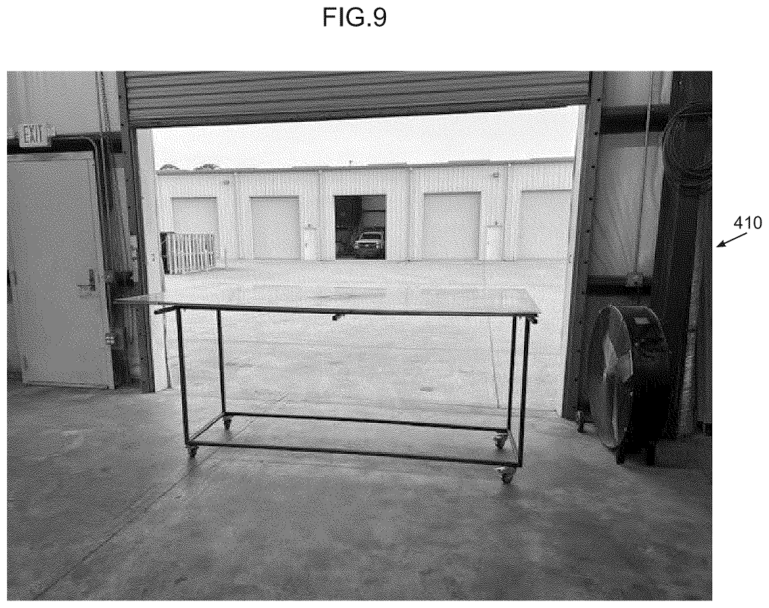

Following the pressing and heating process, the hemp-based panel may undergo a cooling phase to allow for proper stabilization and handling. FIG. 9 shows an orthogonal view of a manufacturing area with a cooling assembly. The figure depicts a transfer to cooling area 410 where manufactured panels are placed after being removed from the press.

In some cases, a remove molding plate 400 operation may be performed to separate the pressed panel from the molding plate used during the forming and pressing stages. The remove molding plate 400 step may involve carefully lifting or sliding the panel and plate assembly from the press to prevent damage to the newly formed panel.

The transfer to cooling area 410 may involve moving the panel and plate assembly to a designated cooling rack or platform. This cooling area may be designed to allow for uniform cooling of the panels under controlled conditions. The duration of the cooling process may vary depending on factors such as panel thickness, density, and ambient conditions. The cooling time may be, not meant to be limiting, from 45 to 60 minutes depending on the ambient temperature and humidity.

Once the panel has cooled sufficiently, a remove board from plate 420 operation may be carried out to separate the finished panel from the molding plate. This step may require careful handling to prevent warping or damage to the panel as the hemp input 110 and binder continue to stabilize.

After removal from the plate, a trim board 430 process may be performed to achieve the final panel dimensions. The trim board 430 operation may involve cutting the panel to standard sizes or custom dimensions as required for specific applications. In some cases, the trimming process may be carried out using automated cutting equipment to ensure precise and consistent results. In other cases the trimming process may use, not meant to be limiting, table saws, circular saws, jig saws, or other cutting devices.

The cooling and post-processing stages may be critical for achieving the desired final properties of the hemp-based panel products. Proper cooling may help prevent warping or internal stresses that could affect panel performance. The trimming process may ensure that the panels meet specified dimensional requirements for various applications.

In some cases, various finishing options may be applied to the hemp-based panels after the trim board 430 process. These finishing options may include direct lamination, where a decorative or protective layer is bonded directly to the panel surface. Vinyl and paper overlays may also be applied to enhance aesthetics or provide additional surface protection.

The hemp-based panels may accept a range of surface treatments, including paints and stains. Water-based sealers may be applied to enhance moisture resistance or provide a specific surface finish. In some cases, digital printing techniques may be used to create custom patterns or designs on the panel surface.

For applications requiring a natural wood appearance, wood veneers may be applied to the hemp-based panels. The compatibility of these various finishing options with the hemp-based substrate may allow for versatility in design and application of the panel products.

The selection of specific finishing treatments may depend on factors such as the intended use of the panels, environmental conditions, and aesthetic requirements. The ability to accept a wide range of finishes may enhance the versatility and market potential of the hemp-based panel products.

The hemp-based panel products may incorporate additional natural fibers to create variations with unique properties and performance characteristics. Two such variations are CannaBran and CannaCane, which combine hemp with wheat bran and bagasse, respectively.

CannaBran may be produced by combining hemp input with wheat bran. The incorporation of wheat bran into the panel composition may alter the physical and mechanical properties of the finished product. In some cases, the ratio of hemp to wheat bran in CannaBran panels may range from 25% hemp/75% wheat bran to 75% hemp/25% wheat bran. This flexibility in composition may allow for customization of panel characteristics to suit specific application requirements.

The addition of wheat bran to the hemp-based panel may influence factors such as density, strength, and moisture resistance. In some cases, CannaBran panels may exhibit a density range of 30 to 45 pounds per cubic foot. The specific density achieved may depend on the ratio of hemp to wheat bran used in the panel formulation.

CannaCane represents another variation of hemp-based panels, incorporating bagasse, a byproduct of sugarcane processing, into the panel composition. The combination of hemp and bagasse may result in panels with distinct properties compared to standard hemp-based products. In some cases, the ratio of hemp to bagasse in CannaCane panels may vary from 25% hemp/75% bagasse to 75% hemp/25% bagasse.

The incorporation of bagasse into the panel composition may affect characteristics such as panel density, dimensional stability, surface texture, and moisture resistance. In some cases, CannaCane panels may have a density range of 25 to 50 pounds per cubic foot. The specific density achieved may be influenced by the ratio of hemp to bagasse used in the panel formulation.

Both CannaBran and CannaCane variations may utilize the same manufacturing processes as standard hemp-based panels, including mixing, forming, pressing, and finishing operations. However, the inclusion of wheat bran or bagasse may require adjustments to process parameters such as mixing time, binder content, or pressing conditions to achieve optimal panel properties.

The use of additional natural fibers in CannaBran and CannaCane panels may offer potential benefits in terms of raw material availability, cost considerations, or specific performance attributes. These variations may expand the range of applications for hemp-based panel products and provide options for utilizing different agricultural byproducts in panel manufacturing.

In some cases, the particle size distribution of the wheat bran or bagasse components may be adjusted to complement the hemp input and achieve desired panel characteristics. The interaction between hemp fibers and the additional natural fibers may influence factors such as internal bond strength, surface smoothness, and overall panel performance.

The binder content and formulation for CannaBran and CannaCane panels may be optimized to account for the specific properties of the wheat bran or bagasse components. In some cases, the binder percentage or composition may be adjusted to ensure proper adhesion and bonding between the different fiber types present in these panel variations.

The incorporation of wheat bran or bagasse into hemp-based panels may also affect the finishing options and surface treatments that can be applied to CannaBran and CannaCane products. In some cases, these variations may accept different types of laminates, veneers, or coatings compared to standard hemp-based panels.

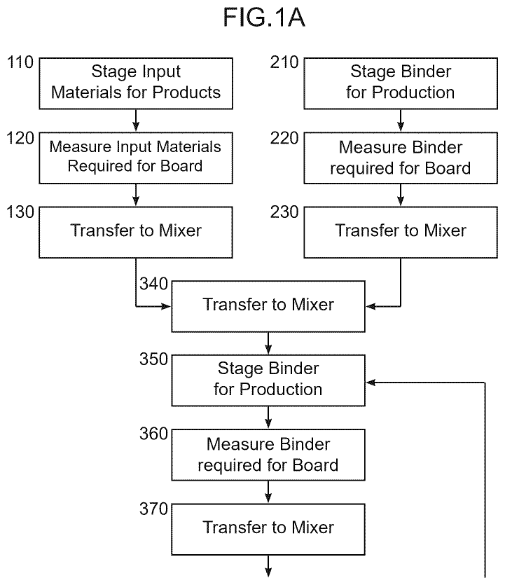

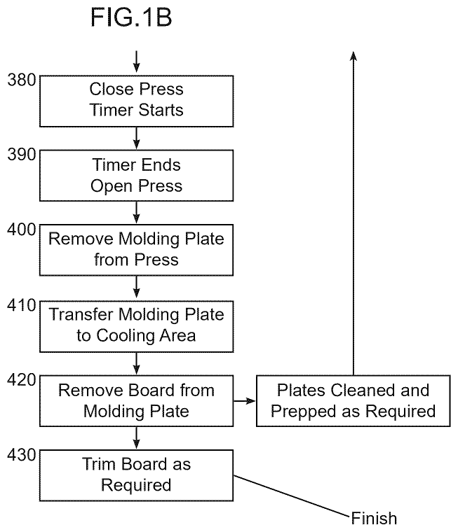

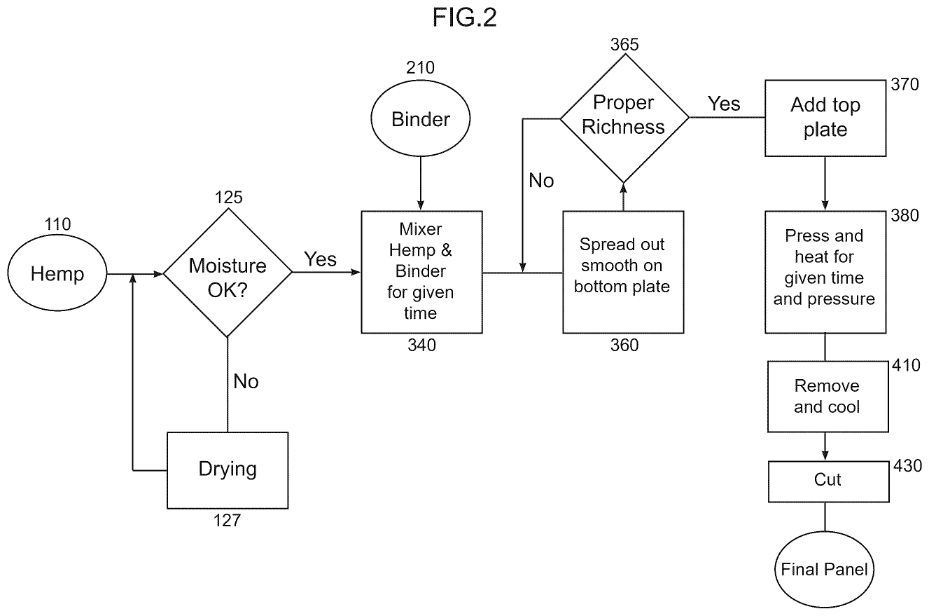

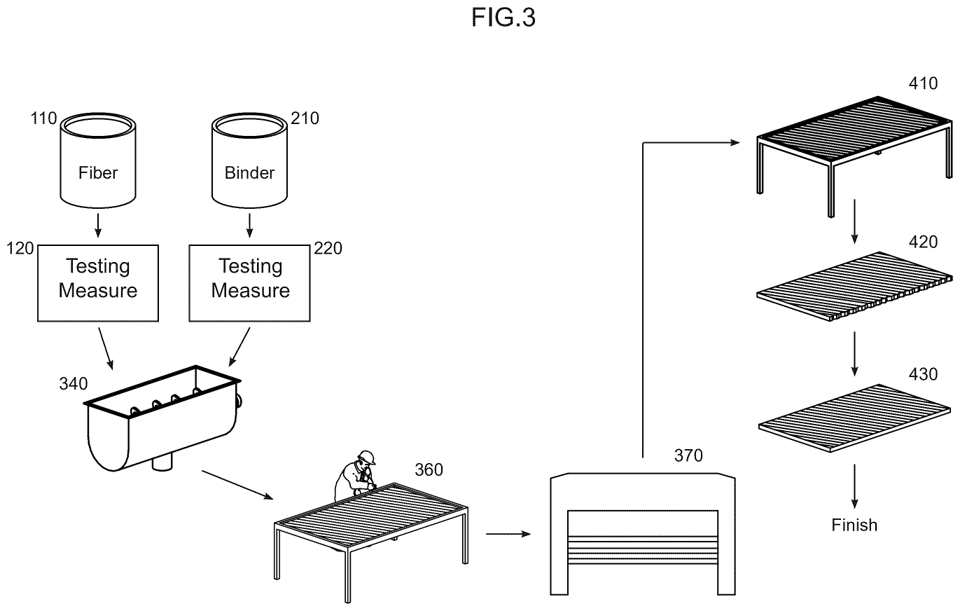

The hemp-based panel manufacturing system may integrate various processes and components to produce panels with customizable properties. FIG. 1A and FIG. 1B illustrate flowcharts depicting the overall manufacturing process, while FIG. 2 and FIG. 3 provide additional details on specific steps and decision points within the system.

The process may begin with a measure input materials 120 step, where the hemp input 110 is quantified and prepared for processing. In some cases, a moisture decision 125 may be made to evaluate the moisture content of the hemp input 110. If the moisture content is outside the desired range, a drying step 127 may be performed to adjust the moisture level of the hemp input 110.

The stage binder 210 and measure binder 220 steps may occur in parallel with the hemp input 110 preparation. These steps may ensure that the appropriate type and quantity of binder are ready for incorporation into the panel mixture.

The transfer hemp to mixer 130 and transfer binder to mixer 230 operations may move the prepared materials into the mixing ribbon blender 340. The mixing process may combine the hemp input 110 and binder to create a uniform mixture suitable for panel formation.

Following the mixing process, the transfer to molding plate 350 step may move the blended material onto a forming surface. The screed mix level 360 operation may then spread the mixture evenly across the molding plate. A proper measure decision 365 may be made to ensure the material distribution and thickness meet the desired specifications.

The transfer to press 370 operation may move the formed mixture into a press for curing and consolidation. The close press/start timer 380 step may initiate the pressing and heating cycle, during which the binder may be activated and the panel structure may be formed.

After the timer ends/open press 390 signal, the remove molding plate 400 operation may separate the pressed panel from the molding plate. The panel may then undergo cooling before the remove board from plate 420 step is performed. The cooling time may be, not meant to be limiting, from 45 to 60 minutes depending on the ambient temperature and humidity.

The final stage in the manufacturing process may be the trim board 430 operation, where the panel is cut to the desired dimensions.

The integrated system may allow for the production of hemp-based panels with varying densities to suit different applications. In some cases, Hempboard panels may have a density range of 20 to 35 pounds per cubic foot. Cannabran panels, which incorporate wheat bran, may exhibit densities between 30 and 45 pounds per cubic foot. Cannacane panels, combining hemp with bagasse, may have densities ranging from 25 to 50 pounds per cubic foot.

The flexibility in density ranges may allow for customization of panel properties to meet specific performance requirements. Lower density panels may offer weight advantages in certain applications, while higher density panels may provide enhanced strength and durability.

In some cases, fire-retardant binder formulations may be incorporated into the panel manufacturing process. These formulations may enhance the fire resistance of the hemp-based panels, potentially expanding their suitability for applications with stringent fire safety requirements.

The integrated manufacturing system for hemp-based panels may offer several potential advantages over traditional wood-based panel production. The use of rapidly renewable hemp as a primary raw material may reduce reliance on forest resources. The ability to incorporate agricultural byproducts such as wheat bran or bagasse may provide additional sustainability benefits.

The customizable nature of the hemp-based panel manufacturing process may allow for the production of panels with specific performance characteristics tailored to various applications. This flexibility may enable the creation of panels that meet or exceed the properties of traditional wood-based alternatives while offering potential environmental advantages.

FIG. 2 illustrates a flowchart depicting a detailed process for manufacturing hemp-based panels. The process begins with the hemp input 110, which undergoes a moisture decision 125 to evaluate the moisture content of the raw materials. In some cases, the moisture content of the hemp input 110 may range from 5% to 15%, with a preferred range of 8% to 12%. If the moisture content is outside the desired range, a drying step 127 may be performed to adjust the moisture level of the hemp input 110.

After achieving the proper moisture content, or if the initial moisture content was acceptable, the process continues with the stage binder 210 being prepared. The stage binder 210 operation may involve controlling the temperature of the binder. In some cases, the binder temperature may range from 80° F. to 100° F. This temperature range may help ensure proper viscosity for mixing with the hemp materials.

The viscosity of the binder may be an important factor in the manufacturing process. In some cases, the binder viscosity may range from 200 to 700 centipoise. This viscosity range may allow for effective distribution of the binder throughout the hemp mixture while maintaining proper flow characteristics during the manufacturing process. The viscosity may be measured with, but not limited to, a rotary viscometer.

The hemp input 110 and binder are then combined in the mixing ribbon blender 340. The binder percentage used in the mixture may vary depending on the desired panel properties. In some cases, the binder percentage may range from 1-3% by volume, which may correspond to approximately 4% to 12% by weight, depending on the density of the panel being produced.

The mixing ribbon blender 340 creates a random three-dimensional distribution of the hemp particles. During mixing, the hemp particles become oriented in various directions-horizontal, vertical, and angles in between-which enhances the structural properties of the final panel.

Following the mixing operation, the material transfers to the screed mix level 360, where the mixture spreads evenly across the molding plate surface. At the proper measure decision 365, the spread undergoes evaluation. If the proper measurement is achieved, the process continues to the transfer to press 370. If not, the material returns to the screed mix level 360 for adjustment.

Although the material spreads evenly across the molding plate, the random three-dimensional orientation of hemp particles established during mixing remains preserved. The particles maintain their varied orientations ranging from horizontal alignment with the panel plane to vertical orientation perpendicular to the surface, as well as angles between these extremes. This multi-directional fiber arrangement contributes to the panel's overall strength and structural integrity.

Once transferred to the press, the close press/start timer 380 initiates the pressing operation. After the pressing cycle completes, a transfer to cooling area 410 may be performed to allow the pressed panel to cool and stabilize. The final step in the process is the trim board 430, where the panel is cut to its final dimensions.

The detailed manufacturing process illustrated in FIG. 2 incorporates several critical steps, including moisture content evaluation, precise binder preparation, thorough mixing, even material distribution, and controlled pressing and cooling operations. These steps may contribute to the production of hemp-based panels with consistent quality and desired performance characteristics.

FIG. 3 illustrates a flowchart depicting an alternative process for manufacturing hemp-based panels. This process emphasizes parallel material preparation, mixing operations, and post-pressing steps.

FIG. 4 shows a section view of a hemp panel product during manufacturing. The image depicts the hemp input 110 that has been mixed with a binder and formed into a panel shape. The hemp input 110 appears to have been pressed and compressed into a uniform thickness, showing the consolidated structure of the hemp and binder mixture.

In some cases, the hemp input 110 may comprise different ratios of hemp hurd, fiber, and dust. The specific composition of the hemp input 110 may affect the properties and performance characteristics of the final panel product. The section view in FIG. 4 reveals the internal composition and density of the pressed material, demonstrating how the hemp input 110 has been transformed into a solid panel form through the manufacturing process.

FIG. 5 shows a section view of the mixing ribbon blender 340. The mixing ribbon blender 340 may be a key component in the manufacturing process for combining the hemp input 110 and binder materials.

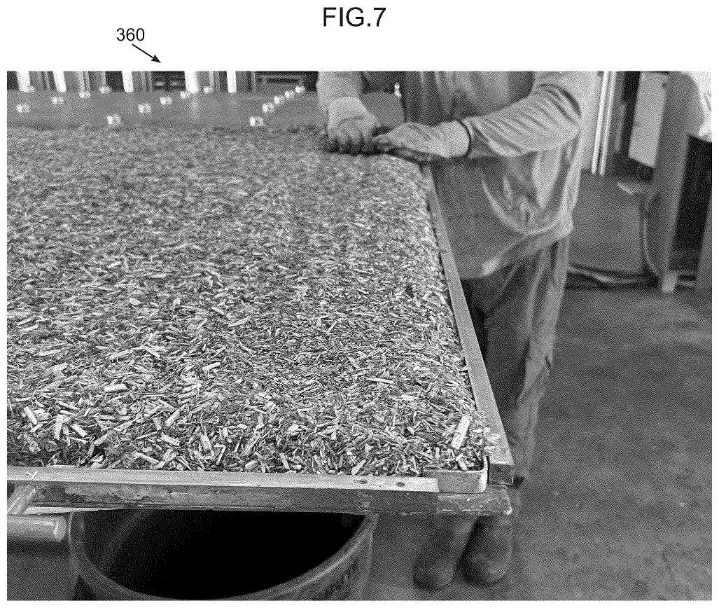

FIG. 7 shows a section view of the screed mix level 360 operation. The image depicts the screed tool in contact with the hemp-binder mixture, illustrating how the material may be spread and leveled during this process. In some cases, the screed tool may be adjusted to different heights to accommodate various panel thicknesses.

The screed mix level 360 may also help eliminate air pockets or voids within the hemp-binder mixture. As the screed tool moves across the surface, it may apply pressure to the material, potentially compacting it slightly and removing trapped air. This compaction may contribute to the overall density and structural integrity of the finished panel.

In some cases, the screed mix level 360 may be performed multiple times to achieve the desired material distribution and thickness. The process may involve moving the screed tool in different directions or patterns across the surface to ensure thorough and even spreading of the hemp-binder mixture.

The effectiveness of the screed mix level 360 may be influenced by factors such as the viscosity of the hemp-binder mixture, the particle size distribution of the hemp input 110, and the desired final panel thickness. In some cases, the speed and pressure applied during the screed mix level 360 operation may be adjusted to accommodate different material compositions or panel specifications.

Following the screed mix level 360, a proper measure decision 365 may be made to evaluate whether the material distribution and thickness meet the desired specifications. In some cases, this decision may involve visual inspection or automated measurement techniques to ensure the panel formation is proceeding as intended.

The screed mix level 360 may play a crucial role in preparing the hemp-binder mixture for subsequent processing steps, such as the transfer to press 370 operation. By ensuring uniform material distribution and thickness, the screed mix level 360 may contribute to the consistency and quality of the finished hemp-based panels.

FIG. 8 shows an orthogonal view of a manufacturing setup for pressing hemp board materials. The image depicts a transfer to press 370 operation, where the prepared material assembly may be moved into the press for the application of heat and pressure.

In some cases, the transfer to press 370 may utilize a roller system to facilitate smooth movement of the plate assembly into the press chamber. The roller system may help ensure careful handling of the formed hemp-binder mixture during the transfer process.

Once the material is positioned in the press, the close press/start timer 380 step may be initiated to begin the pressing and heating cycle. The pressing and heating process may cure the binder and contribute to desired panel properties.

In some cases, the press heat may range from 140° C. to 160° C. This temperature range may allow for proper activation and curing of the binder while avoiding potential degradation of the hemp input 110. The press pressure applied during the curing process may range from 15-20 MPa. This pressure range may help ensure proper compaction of the hemp-binder mixture and facilitate the formation of a uniform, dense panel structure.

The duration of the pressing and heating cycle may vary depending on factors such as panel thickness, press temperature, and binder characteristics. The timer ends/open press 390 step may signal the completion of the curing process.

Following the pressing operation, FIG. 9 shows an orthogonal view of a manufacturing area with a cooling assembly. The figure depicts a transfer to cooling area 410 where manufactured panels may be placed after being removed from the press.

The hemp-based panels may accept a range of surface treatments, including paints and stains. Water-based sealers may be applied to enhance moisture resistance or provide a specific surface finish. For applications requiring a natural wood appearance, wood veneers may be applied to the hemp-based panels.

The trim board 430 process may be performed as the final step to achieve the desired panel dimensions. The trim board 430 operation may involve cutting the panel to standard sizes or custom dimensions as required for specific applications.

The assembly line production process comprises parallel processing stations with automated material handling systems, including:

### Material Preparation Station:

Automated moisture content monitoring system for hemp input verification (125)
Multiple material staging areas for hemp components and binder preparation (110, 210)
Automated conveyor system for material transport between stations

### Mixing Station:

Multiple 200-liter ribbon blenders operating in parallel (340)
Automated binder distribution system maintaining temperature between 80-100° F.
Continuous feed system enabling 7-8 minute mixing cycles per batch

### Forming Station:

Automated spreading and leveling system for consistent material distribution (360)
Multiple molding plate assemblies with integrated release agent application
Computer-controlled thickness monitoring and adjustment

### Press Station:

Multi-daylight press system with 4-6 pressing stations
Independent temperature control (140-160° C.) and pressure regulation (15-20 MPa)
Automated loading/unloading system with 20-minute press cycles

### Post-Processing Station:

Multiple cooling rack assemblies with controlled airflow
Automated panel removal and stacking system
Computer numerical control (CNC) cutting station for precise dimensioning

### Quality Control Station:

Automated thickness and density measurement
Surface quality inspection system
Environmental performance monitoring equipment

In the preceding mass production description various times, temperatures, and pressures may be modified as needed to best support continuous production.

In the preceding detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures.

Different features, variations and multiple embodiments have been shown and described. The embodiments described in this application are for illustrative purposes and do not limit the scope of what has been conceived. This disclosure encompasses many modifications, variations and other embodiments that will occur to those skilled in the art.

The scope of the disclosure encompasses numerous alternatives, modifications and equivalents. The order of steps in disclosed processes may be altered within the scope of the invention. Unless otherwise indicated, the drawings are to be read together with the specifications and form part of the written description.

As used herein, terminology regarding orientation such as vertical, horizontal, top, bottom, front, back, end and sides refers to the views presented. These terms serve only for description and not limitation. Orientation of objects may change without departing from the scope of the disclosure.

The preceding detailed description is not to be taken in a limiting sense, and the scope of the present disclosure is defined only by the appended claims, along with the full scope of equivalents to which such claims are entitled.

What is claimed:

1. A hemp panel, comprising:
a mixture of hemp hurd, fiber, and dust arranged in a random distribution;
wherein the mixture has a moisture content between 5% and 15%;
wherein the mixture comprises 79-91% hemp material by weight and 1-3% binder by volume;
wherein the panel has a density between 20 and 50 pounds per cubic foot;
wherein the panel is formed by pressing under heat between 140-160° C. and pressure of 15-20 MPa.

2. The hemp panel of claim 1, wherein the hemp material comprises particles sized between 0.25 mm and 4 mm.

3. The hemp panel of claim 1, further comprising wheat bran combined with the hemp material in a ratio between 25:75 and 75:25 to form a CannaBran panel having a density between 30-45 pounds per cubic foot.

4. The hemp panel of claim 1, further comprising bagasse combined with the hemp material in a ratio between 25:75 and 75:25 to form a CannaCane panel having a density between 25-50 pounds per cubic foot.

5. The hemp panel of claim 1, wherein the binder is selected from the group consisting of:
agricultural-based adhesives comprising soy-based adhesives, hemp-based adhesives, wheat-based adhesives, and flower-based adhesives; and
fossil fuel-based adhesives comprising urea formaldehyde, phenol formaldehyde, melamine urea formaldehyde, polyvinyl acetate, polyurethane, emulsion polymeric isocyanates, and melamine formaldehyde.

6. The hemp panel of claim 1, wherein the binder has a temperature between 80° F. and 100° F. during mixing.

7. The hemp panel of claim 1, wherein the panel exhibits 80-90% less thickness swelling than particleboard.

8. The hemp panel of claim 1, wherein the binder has a viscosity between 200-700 centipoise.

9. The hemp panel of claim 1, wherein the hemp material comprises:
50-90% particles between 2 mm and 4 mm for hempcrete grade;
50-80% particles between 0.25 mm and 4 mm for dirty hurd grade; or
50-90% particles between 0.25 mm and 2 mm for fines grade.

10. The hemp panel of claim 1, further comprising a surface treatment selected from the group consisting of:
direct lamination;
vinyl overlay;
paper overlay;
paint;
stain;
water-based sealer; and
wood veneer.

11. The hemp panel of claim 1, further comprising a fire-retardant binder formulation.

12. The hemp panel of claim 1, wherein the panel demonstrates:
54-72% lower Global Warming Potential compared to wood-based panels;
40-54% lower energy consumption; and
47% decreased water usage.

13. A method for manufacturing the hemp panel of claim 1, comprising:
providing the hemp material;
measuring moisture content;
adjusting moisture content to between 5-15% if outside the range;
mixing with the binder at 80-100° F. for 7-8 minutes;
spreading evenly on a molding plate;
pressing under heat between 140-160° C. and pressure of 15-20 MPa; and
cooling to form the panel.

14. The method of claim 13, further comprising trimming the cooled panel to desired dimensions.

15. The method of claim 13, wherein the binder is selected from the group consisting of:
agricultural-based adhesives comprising soy-based adhesives, hemp-based adhesives, wheat-based adhesives, and flower-based adhesives; and
fossil fuel-based adhesives comprising urea formaldehyde, phenol formaldehyde, melamine urea formaldehyde, polyvinyl acetate, polyurethane, emulsion polymeric isocyanates, and melamine formaldehyde.

16. The method of claim 13, wherein the panel exhibits 80-90% less thickness swelling than particleboard.

17. The method of claim 13, wherein the panel comprises between 79-91% renewable content.

18. The method of claim 13, wherein the panel demonstrates:
54-72% lower Global Warming Potential;
40-54% lower energy consumption; and
47% decreased water usage compared to traditional wood-based panels.

19. A system for manufacturing hemp panels, comprising:
a moisture meter for measuring moisture content;
a drying apparatus for adjusting moisture content to between 5-15%;
a ribbon blender for mixing materials for 7-8 minutes;
a binder temperature control system maintaining 80-100° F.;
a press configured to apply heat between 140-160° C. and pressure of 15-20 MPa;
a molding plate assembly; and
a cooling rack.

20. The system of claim 19, further comprising trimming the cooled panel to desired dimensions.
